(19) United States
(12) Patent Application Publication
(10) Pub. No.: US 2008/0059623 A1
(43) Pub. Date: Mar. 6, 2008

(54) Management system and method of network elements using simple network management protocol

(76) Inventors: Won-Jong Yang, Suwon-si (KR); Jae-Won Bum, Yongin-si (KR)

Correspondence Address: ROBERT E. BUSHNELL, 1522 K STREET NW, SUITE 300, WASHINGTON, DC, 20005-1202, US

(21) Appl. No.: 11/882,315

(22) Filed: Jul. 31, 2007

(30) Foreign Application Priority Data
Sep. 5, 2006 (KR) 10-2006-0085143

(51) Int. Cl. G06F 15/173

(52) U.S. Cl. 709/223

(57) ABSTRACT

An NE management system and method using SNMP manages NEs and updates a management information list thereof without confusion even though NE settings are changed. The NE management system includes an NE and a management server. The NE generates NE settings in response to a setting change, transmits the NE settings to the management server, and receives a complete message from the management server. The management server receives the NE settings from the NE, acquires an element type of the NE based upon the received NE settings to determine an MIB to use, manages a registration list, and notifies the NE that a registration process is accomplished. The NE management method and system integrate registration and management of a plurality of NEs in a ubiquitous environment where various types and versions of the NEs exist together.

### CLAIM OF PRIORITY

This application makes reference to, incorporates the same herein, and claims all benefits accruing under 35 U.S.C. §119 from an application for MANAGEMENT SYSTEM AND METHOD OF NETWORK ELEMENTS USING SIMPLE NETWORK MANAGEMENT PROTOCOL earlier filed in the Korean Intellectual Property Office on the 5^{th} of Sep. 2006 and there duly assigned Serial No. 2006-0085143.

### BACKGROUND OF THE INVENTION

1. Technical Field

The present invention relates to a registration method and system of network elements (NEs) in a network management system using Simple Network Management Protocol (SNMP), and more particularly, which method and system can manage the NEs and update a management information list thereof without confusion even though NE settings are changed.

2. Related Art

The terminology “NE” used herein indicates a network element which a management server is supposed to manage in a network management system. Examples of the NE include a switch, a router, a hub, a bridge, a printer, a computer, a modem and a set-top box, together with any other network elements which can be managed by the management server via a network.

According to the development of info-communication technologies, service subscribers demand more rapid and various services and, accordingly, such demands are further accelerating the developing speed of network systems.

To date, info-communication networks have an open architecture and are managed based upon various and complicated management methods and various operation systems.

In general, the network management system is used to stably manage a network wherein a plurality of systems are connected together. The network management system includes a management server and NEs or systems in a network, the management server being connected directly or indirectly with the NEs (or systems) and managing the NEs by receiving status information of the NEs. The status information may include operation status and execution information of the NEs (or systems) in addition to trouble information thereof. The network management system constantly monitors the status of the communication network using such status information to optimize the same.

There are various examples of the network management system, including a Network Management System (NMS), an Element Management System (EMS) and a Service Management System (SMS), which are used in various architectures adequate for network situations.

To date, a network management method using SNMP is being widely adopted in the network management system. In the case of SNMP, the network management system includes an SNMP manager and an SNMP agent, the SNMP manager operating in the management server, and the SNMP agent operating in each of the NEs. The SNMP manager can change or confirm the settings of the SNMP agent based upon an SNMP request message, and the SNMP agent can report information to the SNMP manager via an SNMP trap message. The structure of the SNMP messages are specified according to a known standard, and thus will not be described further.

The management server in the network management system can make a reference or a change to management information of the NEs which the management server is supposed to manage only if the same management information is previously acquired. Such an information model is referred to as a Management Information Base (MIB), which has to be defined equally between the management server and the NE in order to avoid errors. Since the MIB is set variously according to NE types and even the same NE has various versions, the management server must previously recognize the MIBs according to the NEs. Conventionally, the NEs can be identified based upon respectively fixed IP addresses that the respective NEs use. However, recently, NEs to be managed are exponentially increasing in number in response to dramatic growth of Internet use, and thus available IP addresses are being exhausted. In order to solve such a problem, Dynamic Host Configuration Protocol (DHCP) is used to dynamically allocate IP addresses and to withdraw IP addresses if not used. In the case of allocating the IP addresses by dynamically utilizing the DHCP, the respective NEs are not allocated with a fixed IP address, and thus the MIBs cannot be identified based upon the IP addresses any longer.

Thus, various problems or drawbacks exist in currently used network management systems. For example, a system based on fixed IP addresses has a problem when IP addresses are changed. Moreover, in certain cases, a device such as an ADSL modem, a VDSL modem and a set-top box has its IP address changed when power to the device is turned on/off, causing problems in a system which is based on fixed IP addresses.

### SUMMARY OF THE INVENTION

The present invention has been developed to solve the foregoing problems, and therefore an object of the present invention is to provide an NE management system and method using SNMP and which can manage NEs and update a management information list thereof without confusion even though NE settings are changed.

Another object of the present invention is to provide an NE management method and system using standardized SNMP and which can integrate registration and management of a plurality of NEs in a ubiquitous environment where various types and versions of the NEs exist together.

According to an aspect of the invention for realizing the above objects, an NE management system using SNMP includes an NE and a management server. The NE generates NE settings in response to a setting change, transmits the NE settings to a management server, and receives a complete message from the management server, and the management server receives the NE settings from the NE, acquires an element type of the NE based upon the received NE settings so as to determine an MIB to use, manages a registration list, and notifies the NE that a registration process is accomplished.

Preferably, the NE settings include a Media Access Control (MAC) address, an IP address and a system object identifier, and the NE includes a setting change checker generating the NE settings when the NE is initially registered or when there is a change in the NE settings.

Preferably, an SNMP agent of the NE transmits the NE settings generated by the NE using a cold start SNMP trap message.

Preferably, after the NE settings are transmitted to the management server, the NE stands by for a system identifier to be received for a preset time period and, if the system identifier is not received, retransmits the NE settings to the management server.

Preferably, the management server includes an MIB setter which acquires an element type and a version of the NE with reference to the system object identifier of the NE settings and determines an MIB to use in the management of the NE.

Preferably, the management server includes a registration list manager for extracting the MAC address from the received NE settings, and for comparing the extracted MAC address with a MAC address data of a current registration list. If the extracted MAC address is identical to the MAC address data, the registration list manager determines that the NE is already registered, compares the received NE settings with corresponding NE settings in the registration list, and updates the registration list with the received NE settings. If the extracted MAC address is not identical to the MAC address data, the registration list manager determines that the NE is carrying out an initial registration process, adds the MAC address as new data to the registration list, and registers the received NE settings in the registration list.

Preferably, the management server includes a system identifier setter for setting the system identifier of the NE after the registration or the updating of the registration list is accomplished, and for transmitting the set system identifier to the NE, thereby reporting that the registration or the updating has been accomplished.

Preferably, the SNMP manager transmits the system identifier via an SNMP set request message.

According to another aspect of the invention for realizing the above objects, an NE management method using SNMP comprises the steps, at an NE, of: initially connecting to a network management system using the SNMP and determining whether an initial registration is required or NE settings are changed; if the initial registration is required or the NE settings are changed, transmitting the NE settings, including a MAC address, an IP address and a system object identifier, to a management server; determining whether a system identifier is received from the management server after the NE settings are transmitted; and normally stopping the process if the system identifier is received from the management server within a preset time period as a result of the determining step.

Preferably, the NE management method further includes the step of retransmitting the NE settings to the management server if the system identifier is not received from the management server within a preset time period as a result of the confirming step.

Preferably, the SNMP agent transmits the NE settings generated by the setting change checker to the management server using a cold start SNMP trap message.

According to a further aspect of the invention for realizing the above objects, an NE management method using SNMP comprises the steps, at a management server, of: standing by for NE settings to be received from an NE which is managed by the management server; receiving the NE settings, including a MAC address, an IP address and a system object identifier, from the NE; determining whether the NE is already registered in a registration list using the NE settings received in the receiving step; if the NE is not registered as a result of the determining step, determining that an initial registration process has been carried out and adding the received NE settings to the registration list; allocating a system identifier to the NE after the step of adding the NE settings to the registration list is accomplished; if the NE is already registered as a result of the determining step, comparing the NE settings with information stored in the registration list to update the registration list with a change; and transmitting the system identifier allocated to the NE after the step of adding the NE settings to the registration list and allocating the system identifier are accomplished or after the step of updating the registration list is accomplished.

Preferably, the step of determining whether the NE is already registered in a registration list using the received NE settings includes determining whether a MAC address data of the registration list is identical to the MAC address extracted from the NE settings.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a schematic view of the architecture of a network management system;

FIG. 2 is a schematic view of the architecture of an NE management system using SNMP according to an embodiment of the invention;

FIG. 3 is a block diagram of the structure of a management server according to an embodiment of the invention;

FIG. 4 is a block diagram of the structure of an NE according to an embodiment of the invention;

FIG. 5 is a flowchart of the operation of the management server according to the invention; and

FIG. 6 is a flowchart of the operation of the NE according to the invention.

### DETAILED DESCRIPTION OF THE INVENTION

The following detailed description in conjunction with the accompanying drawings will present preferred embodiments of NE management system and method using SNMP according to the present invention. It shall be apparent to those skilled in the art that the system architecture as will be illustrated and described hereinafter is merely illustrative, and is not intended to limit the present invention.

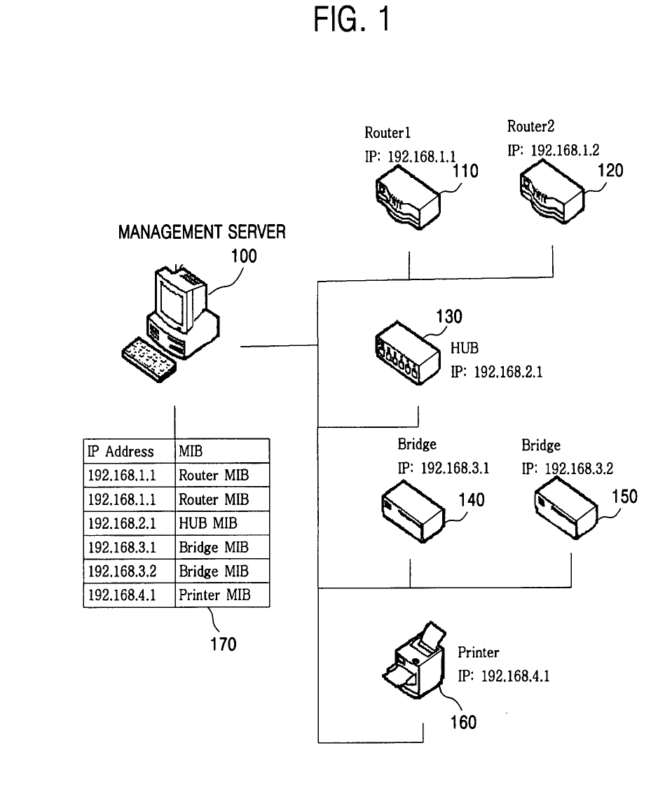

FIG. 1 is a schematic view of the architecture of a network management system.

A network management system includes a plurality of NEs 110 to 160 and a management server 100. Each of the NEs 110 to 160 has a unique fixed IP address and a unique list 170 of an MIB to be used in each NE classified by IP address. The list 170 is determined at the initial establishment of the network management system, and can be used when the IP address of the NEs are fixed since the NEs are classified according to the IP addresses. In the case where a new NE is added or the IP address of each NE is changed, the operator of the management server 100 must change the IP address of the list and the MIB in person. Since different MIBs are used according to the type and the version of the NEs, the MIB to be used according to the NE is determined using the IP address. If the IP address is changed, the management server 100 managing a plural number of the NEs cannot determine the MIB to be used for the management of the NE. If a wrong MIB is used for the NE, a fatal error may be caused in the operation of the NE, potentially unstabilizing the entire system.

Furthermore, as a frequently used method of effectuating IP use, the DHCP server dynamically allocates and withdraws IP addresses. However, this approach also causes some problems, which become more serious, for example, in an ADSL modem, a VDSL modem and a set-top box where electric power is turned on/off. Whenever the electric power is turned on/off, a new IP address different from a previous one may be allocated, and thus the MIB for identifying the fixed ID address is not available any longer. Accordingly, there are strong demands for a novel approach which, even though the network settings such as the IP address are changed in the network management system, can manage the NEs without confusion due to changed NE settings.

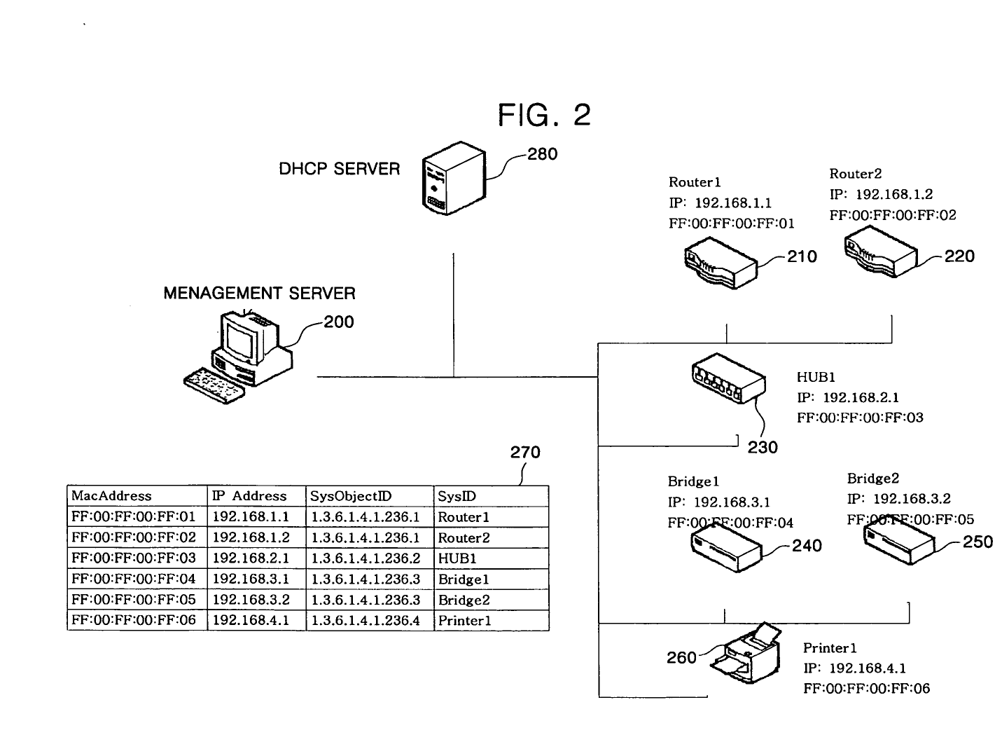

FIG. 2 is a schematic view of the architecture of an NE management system using SNMP according to an embodiment of the invention.

The NE management system of the invention includes a management server 200, NEs 210 to 260, and a DHCP server 280. The DHCP server 280 allocates IP addresses or updates terms in response to request messages from the NEs 210 to 260 or withdraws any of the allocated IP addresses which have not been used for a predetermined time period. The operation of the DHCP server 280 is known in the art, and thus will be not described further.

The management server 200 executes a management operation by inquiring and changing the settings of the respective NEs 210 to 260 using SNMP, and generates and updates a registration list 270 using the NE settings received from the NEs 210 to 260.

The NE settings include such information as a Media Access Control (MAC) address, an IP address and a system object identifier (SysObjecID) of the respective NEs 210 to 260. Each NE 210 to 260 transmits the NE settings to the management server 200 through an SNMP trap message when the NE is initially registered in the NE management system or when the NE settings are changed. The MAC address has a 48 bit structure composed of 6×8 bits, the first three bits indicating a unique manufacturer ID allocated by the Institute of Electrical and Electronics Engineers (IEEE) and the second three bits indicating a unique NIC card ID for the same manufacturer. With reference to http://standards.ieee.org/regauth/oui/index.shtml, it is possible to inquire as to ranges allocated to NIC card manufacturers.

Accordingly, the NEs 210 to 260 have unique MAC addresses allocated to them, and the management server 200 uses the unique MAC addresses to manage the registration list 270.

The IP addresses are allocated to the NEs 210 to 260 by the DHCP server 280, and are reported to the management server 200. A change in the IP addresses is reported to the management server 200 through the SNMP trap message, and the management server 200 updates the changed IP address in the management list 270.

The system object identifier indicates a unique number for a manufacturer allocated by the Internet Assigned Numbers Authority (IANA) and a unique number sequentially allocated for a product group for the same manufacturer. Accordingly, it is possible to identify the product group of each NE based upon the system object identifier. With reference to http://www.iana.org/assignments/enterprise-numbers, it is possible to inquire as to product group numbers allocated according to manufacturers. The management server 200 acquires the product group of each NE 210 to 260 based upon the system object identifier so as to determine the MIB.

The management server 200 manages the registration list 270 using the aforementioned NE settings. In greater detail, the management server 200 receives the NE settings from each of the NEs 210 to 260, extracts a MAC address, an IP address and a system object identifier from the NE settings, and determines whether or not the NE is already registered in the registration list 270, which is currently being managed, based upon the MAC addresses. That is, the management server 200 inspects a MAC address item of the registration list 270 to confirm whether or not the MAC address item has data identical to the MAC address included in newly received NE settings. If there is data identical to the MAC address, the management server 200 determines that the NE of the specific MAC address is registered and updates the NE settings in the registration list 270. If there is no data identical to the MAC address, the management server 200 determines that the NE is carrying out an initial registration process, and thus adds the settings of the NE to the registration list 270.

As mentioned above, the management server 200 accomplishes generation and update of the registration list 270 using the NE settings. Then, the management server 200 allocates, to the NE which transmitted the NE settings, a system identifier for identifying the NE from other NEs 210 to 260, and transmits the system identifier to the allocated NE in order to report that the registration or updating is accomplished.

Each of the NEs 210 to 260 which transmitted the NE settings stands by to receive the system identifier transmitted by the management server 200. If the system identifier is not received within a preset time period, the NE concludes that the transmission of the NE settings has failed, and retransmits the NE settings to the management server 200. In this way, the problem of packet loss caused by an SNMP packet being delivered to a UDP is solved.

The process of the management server 200 in registering a new NE in the registration list 270 or in updating the registration list 270 is described in detail as follows.

It will be assumed that the printer NE 260 is connecting to the NE management system of FIG. 2 for the first time. In this case, the registration list 270 of the management server has contents as shown in Table 1 below. The registration list of Table 1 does not have a printer item.

TABLE 1
Registration List

| MacAddress | IP Address | sysObjectID | SysID |
|---|---|---|---|
| FF:00:FF:00:FF:01 | 192.168.1.1 | 1.3.6.1.4.1.236.1 | Router1 |
| FF:00:FF:00:FF:02 | 192.168.1.2 | 1.3.6.1.4.1.236.1 | Router2 |
| FF:00:FF:00:FF:03 | 192.168.2.1 | 1.3.6.1.4.1.236.2 | HUB1 |
| FF:00:FF:00:FF:04 | 192.168.3.1 | 1.3.6.1.4.1.236.3 | Bridge1 |
| FF:00:FF:00:FF:05 | 192.168.3.2 | 1.3.6.1.4.1.236.3 | Bridge2 |

The printer NE 260 connecting to the NE management system for the first time transmits NE settings to the management server 200. Upon receiving the NE settings, the management server 200 extracts a MAC address from the NE settings for comparison with MacAddresses in the registration list of Table 1. The MAC address of the printer NE 260 is ‘FF:00:FF:00:FF:06’, which is not identical to any of the MacAddress data. Thus, the NE management system determines that the printer NE 260 is accessing for the first time, and adds the MAC address, an IP address and a system object identifier, extracted from the NE settings of the printer NE 260, to the registration list.

TABLE 2
Registration List with Printer NE 260 Added

| MacAddress | IP Address | SysObjecID | SysID |
|---|---|---|---|
| FF:00:FF:00:FF:01 | 192.168.1.1 | 1.3.6.1.4.1.236.1 | Router1 |
| FF:00:FF:00:FF:02 | 192.168.1.2 | 1.3.6.1.4.1.236.1 | Router2 |
| FF:00:FF:00:FF:03 | 192.168.2.1 | 1.3.6.1.4.1.236.2 | HUB1 |
| FF:00:FF:00:FF:04 | 192.168.3.1 | 1.3.6.1.4.1.236.3 | Bridge1 |
| FF:00:FF:00:FF:05 | 192.168.3.2 | 1.3.6.1.4.1.236.3 | Bridge2 |
| FF:00:FF:00:FF:06 | 192.168.4.1 | 1.3.6.1.4.1.236.4 | |

Referring to the registration list of Table 2 above, it is apparent that the NE settings of the printer NE 260 have been added to the last row of the table.

Upon accomplishing the registration process for the new NE 260, the management server 200 allocates a system identifier (SysID) to the NE 260 which transmitted the NE settings. Referring to Table 3 below, it is apparent that the system identifier (SysID) of the printer NE 260 has been allocated as Printer1. Then, the management server 200 reports the allocated system identifier to the printer NE 260 via an SNMP set message.

TABLE 3
Registration List with SysID Allocated to Added Printer NE

| MacAddress | IP Address | SysObjecID | SysID |
|---|---|---|---|
| FF:00:FF:00:FF:01 | 192.168.1.1 | 1.3.6.1.4.1.236.1 | Router1 |
| FF:00:FF:00:FF:02 | 192.168.1.2 | 1.3.6.1.4.1.236.1 | Router2 |
| FF:00:FF:00:FF:03 | 192.168.2.1 | 1.3.6.1.4.1.236.2 | HUB1 |
| FF:00:FF:00:FF:04 | 192.168.3.1 | 1.3.6.1.4.1.236.3 | Bridge1 |
| FF:00:FF:00:FF:05 | 192.168.3.2 | 1.3.6.1.4.1.236.3 | Bridge2 |
| FF:00:FF:00:FF:06 | 192.168.4.1 | 1.3.6.1.4.1.236.4 | Printer1 |

In this case, it will be assumed that the HUB1 NE 230, managed by the NE management system, returns its IP address to the DHCP server 280 as a result of being turned off and then a new printer NE (not shown) is added. The DHCP server 280 periodically inspects to determine whether or not IP addresses allocated to the NEs are being used, withdraws any IP address which is not used for a preset time period, and allocates the withdrawn IP address to another NE which requests an IP address. Accordingly, when the HUB1 NE 230 has not used its allocated IP address for the preset time period (for example, due to being turned off), the DHCP server 280 withdraws the IP address 192.168.2.1 allocated to the HUB1 NE 230. In this situation, when a new NE sends an IP address allocation request to the DHCP server 280, the DHCP server 280 allocates the withdrawn IP to the new NE. When the new printer NE (not shown), to which the IP address 192.168.2.1 is allocated, transmits its NE settings to the management server 200, the management server 200 searches MacAddresses in the registration list of Table 3 to confirm that an identical MAC address does not exist, and adds the received NE settings to the registration list. The management server 200 also allocates a system identifier (SysID) to the new NE, and transmits the allocated system identifier to the new NE. This process is the same as the aforementioned initial registration process for the NE. In this case, since the IP address of the previous HUB1 is the same as the IP address of new Printer2, the IP address of existing HUB1 is deleted. Accordingly, the hub NE 230 is upgraded to an item without the IP address as in the registration list of Table 4 below:

TABLE 4
Registration List with New Printer NEs Added

| MacAddress | IP Address | SysObjecID | SysID |
|---|---|---|---|
| FF:00:FF:00:FF:01 | 192.168.1.1 | 1.3.6.1.4.1.236.1 | Router1 |
| FF:00:FF:00:FF:02 | 192.168.1.2 | 1.3.6.1.4.1.236.1 | Router2 |
| FF:00:FF:00:FF:03 | | 1.3.6.1.4.1.236.2 | HUB1 |
| FF:00:FF:00:FF:04 | 192.168.3.1 | 1.3.6.1.4.1.236.3 | Bridge1 |
| FF:00:FF:00:FF:05 | 192.168.3.2 | 1.3.6.1.4.1.236.3 | Bridge2 |
| FF:00:FF:00:FF:06 | 192.168.4.1 | 1.3.6.1.4.1.236.4 | Printer1 |
| FF:00:FF:00:FF:07 | 192.168.2.1 | 1.3.6.1.4.1.236.4 | Printer2 |

When the HUB1 NE 230 is turned on later, it is allocated a new IP address 192.186.4.2 by the DHCP server 280, and performs an update process by transmitting its NE settings to the management server 200. Then, the management server 200 extracts a MAC address ‘FF:00:FF:00:FF:03’ from the received NE settings, searches MacAddresses in the registration list of Table 4 using the extracted MAC address, confirms that the MAC address is already added to the registration list, and then updates the IP address as changed information in a corresponding block of the registration list.

TABLE 5
Registration List with IP Address of HUB NE 230 Updated

| MacAddress | IP Address | SysObjecID | SysID |
|---|---|---|---|
| FF:00:FF:00:FF:01 | 192.168.1.1 | 1.3.6.1.4.1.236.1 | Router1 |
| FF:00:FF:00:FF:02 | 192.168.1.2 | 1.3.6.1.4.1.236.1 | Router2 |
| FF:00:FF:00:FF:03 | 192.186.4.2 | 1.3.6.1.4.1.236.2 | HUB1 |
| FF:00:FF:00:FF:04 | 192.168.3.1 | 1.3.6.1.4.1.236.3 | Bridge1 |
| FF:00:FF:00:FF:05 | 192.168.3.2 | 1.3.6.1.4.1.236.3 | Bridge2 |
| FF:00:FF:00:FF:06 | 192.168.4.1 | 1.3.6.1.4.1.236.4 | Printer1 |
| FF:00:FF:00:FF:07 | 192.168.2.1 | 1.3.6.1.4.1.236.4 | Printer2 |

The new NE is added to the registration list according to the aforementioned process, and the changed settings of the NE are updated in the registration list.

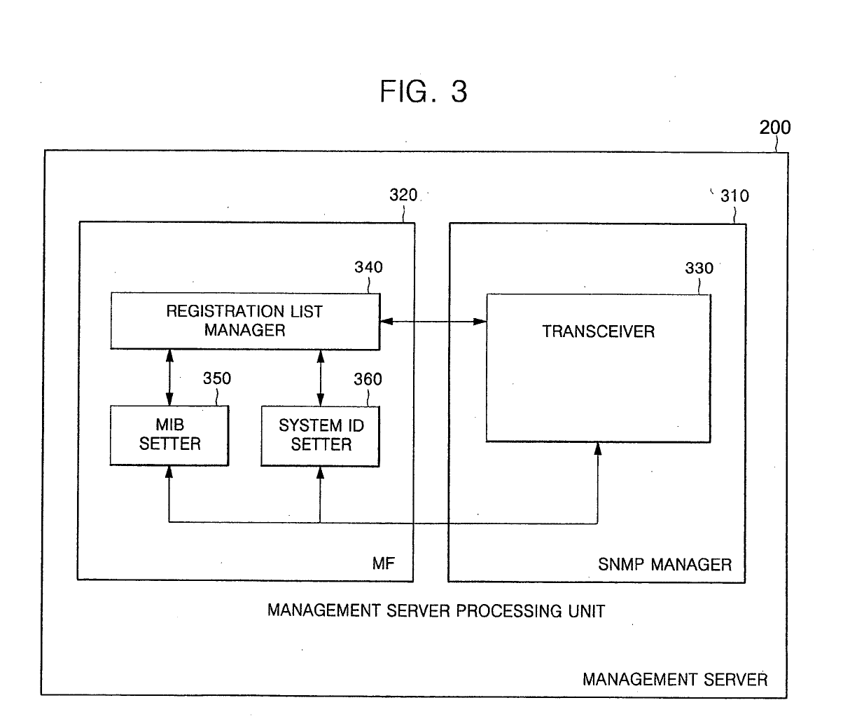

The detailed structure of management server 200 will now be described with reference to FIG. 3, which is a block diagram of the structure of a management server according to an embodiment of the invention.

The management server 200 shown in FIG. 3 includes a management server processing unit, an SNMP manager 310 and a Management Function (MF) 320. While detailed structure is not shown in FIG. 3, the management server processing unit is similar to that of a conventional management server, and thus will not be described in detail.

The SNMP manager 310 includes a transceiver 330 which communicates with an SNMP agent based upon SNMP. In general, the SNMP manager 310 is included in the NE management server 200, and communicates with the SNMP agent in each NE which is managed by the network manager.

Describing the structure of the MF 320 in greater detail, the MF 320 includes a registration list manager 340, an MIB setter 350 and a system identifier (ID) setter 360.

The registration list manager 340 performs the operation of managing the registration list 270 illustrated in FIG. 2. In more detail, the registration list manager 340 receivers NE settings via the transceiver 330 and analyzes the received NE settings. If the MAC address included in the received NE settings does not exist in the registration list 270, the registration list manager 340 newly adds the received NE settings to the registration list 270. If the MAC address exists in the registration list 270, the registration list manager 340 updates the registration list 270 with the received NE settings. Through this process, the NE settings are immediately reflected in the registration list 270 so that the management server 200 can manage the respective NEs with reference to the registration list 270.

The MIB setter 350 acts to determine an MIB, which is to be used by each NE, based upon a system object identifier of the registration list 270. The MIB is different for different manufacturers and products, and may be different according to product versions. In the MIB, items which the management server 300 uses to manage the respective NEs are systematically classified according to object identifiers (OIDs). However, the OIDs are not fixed but can be changed as an NE function is added, as reported in Table 6 below. For example, when the MIB of an NE is changed, the management server 200 may attempt to manage the NE with an old OID without being notified of the change. In this case, the management server 200 may acquire wrong settings or make a change with the wrong settings. Describing this with reference to Table 6 below, when the management server 200 attempts to change ‘system location’ information using the old OID or “1.3.6.1.4.1.1.7” without being notified that the MIB of the NE is changed, ‘systemNewFeature’ information is actually changed in the NE instead of ‘system location’ information. Accordingly, the invention uses the system object identifier in order to solve such a problem.

TABLE 6
Example of Change in MIB

| MIB before changed | MIB after changed |
|---|---|
| “systemName” = “1.3.6.1.4.1.1.5” | “systemName1” = “1.3.6.1.4.1.1.5” |
| “systemTime” = “1.3.6.1.4.1.1.6” | “systemTime” = “1.3.6.1.4.1.1.6” |
| “system location” = “1.3.6.1.4.1.1.7” | “systemNewFeature” = “1.3.6.1.4.1.1.7” |
| | “system location” = “1.3.6.1.4.1.1.8” |

By utilizing the system object identifier, it is possible to determine the manufacturer and the product type of corresponding NEs, as well as to determine MIBs to be used according to the NEs. As mentioned above, in the system object identifier, different numbers are allocated according to manufacturers and, in the case of the same manufacturer, different numbers are allocated according to product groups. Thus, it is possible to allocate a unique system object identifier according to the type and the version of the respective NEs. Accordingly, the MIB setter 350 can confirm the system object identifier of each NE in the registration list 270, and can determine an MIB that the NE must use. Since the system object identifier is included in the settings of the NEs and is transmitted to the management server 200 whenever the settings of the NEs are changed, the management server 200 can immediately update the system object identifier in the registration list 270 whenever the settings of the NEs are changed.

The System ID setter 360 will now be described. After the addition and updating of the registration list 270 is accomplished in the management server 200, the System ID setter 360 allocates unique system identifiers according to the NEs, stores the unique system identifiers in the registration list 270, and transmits the allocated system identifiers to the corresponding NEs through the transceiver 330, thereby accomplishing the process of adding to and updating the registration list 270. The system identifiers (SysID) are transmitted to the corresponding NEs through the SNMP manager 310 of the management server 200, using an SNMP-SET request message. Accordingly, the corresponding NEs are notified that the process of adding to and updating the registration list 270 has been normally accomplished. In the case of not receiving such a system identifier, a corresponding one of the NEs regards the transmission of the NE settings as having failed, and retransmits the NE settings.

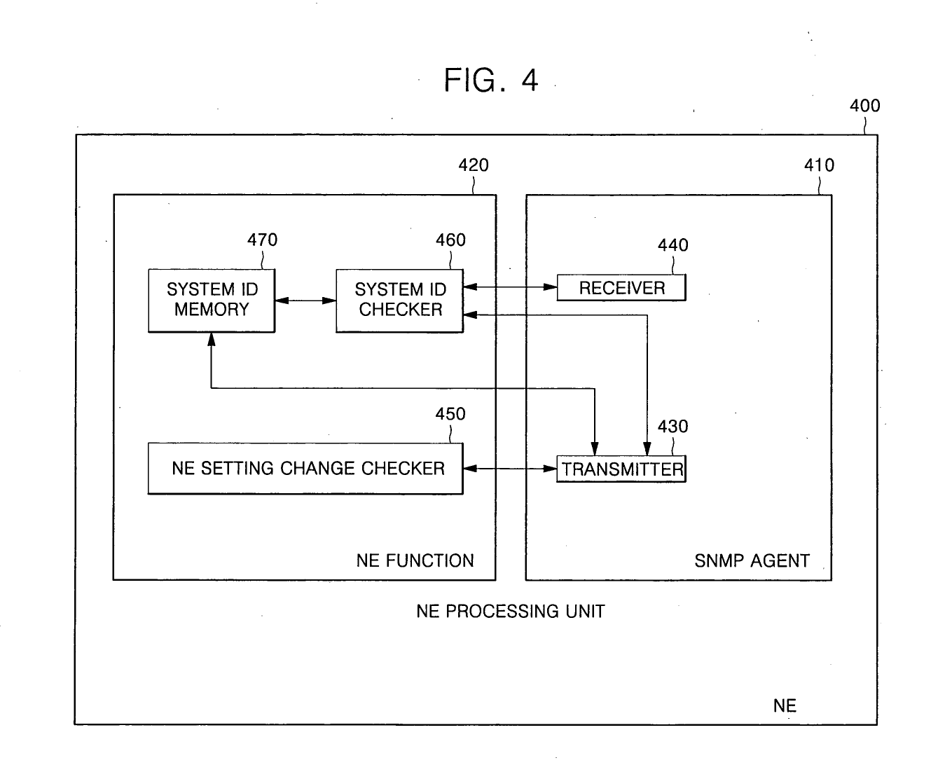

The detailed structure of an NE 400 will now be described with reference to FIG. 4, which is a block diagram of the structure of an NE according to an embodiment of the invention.

The NE 400 includes an NE processing unit which performs unique functions according to the characteristics of the NE, an NE function 420 and an SNMP agent 410. While the structure of the NE processing unit is not specifically illustrated in the drawing, the NE processing unit can be regarded as performing common functions according to NE types. That is, if the NE is a printer, the NE processing unit serves to perform unique functions of the printer. If the NE is a hub, the NE processing unit serves to perform unique functions of the hub. These features are known in the art, and thus will not be described further.

First, describing the structure of the SNMP agent 410, the SNMP agent 410 includes a transmitter 430 and a receiver 440, and performs data communication with the aforementioned SNMP manager 310 of the management server 200 using SNMP.

The NE function 420 includes an NE setting change checker 450, a system identifier (ID) checker 460 and a system identifier (ID) memory 470. The NE setting change checker 450 checks NE settings, including MAC address, IP address and system object identifier (sysObjectID), to find any changes therein and, if there is a change in the NE settings, transmits the NE settings to the management server 200 via the transmitter 430 so as to report the change. In general, the NE settings are transmitted when an NE is initially connecting to the NE management system. When a new IP address is allocated through the DHCP server 280, the version of the NE is changed, and thus the system object identifier is changed, and the changed NE settings are also transmitted.

A cold start (coldStart) SNMP trap message is used to transmit the NE settings. The cold start SNMP trap message is one of the SNMP trap standards defined by RFC1907, and generally acts to notify the SNMP manager 310 of a change in the settings of the SNMP agent 410. The SNMP agent 410 of the NE transmits the NE settings, which include a MAC address, an IP address and a system object identifier, in the cold start SNMP trap message to the SNMP manager 310 of the management server 200. Transmitting the changed NE settings according to a method defined by the SNMP standard makes it possible to integrate the management of the NEs regardless of types, manufacturers and versions.

After the NE settings are transmitted, the system ID checker 460 determines whether or not the system identifier is received within a preset time period. If the system identifier is received within the preset time period, the system ID memory 470 stores the system identifier allocated by the management server 200. If the system identifier is not received within the preset time period, the transmitter 430 retransmits the NE settings in order to compensate for a failed transmission of the NE settings.

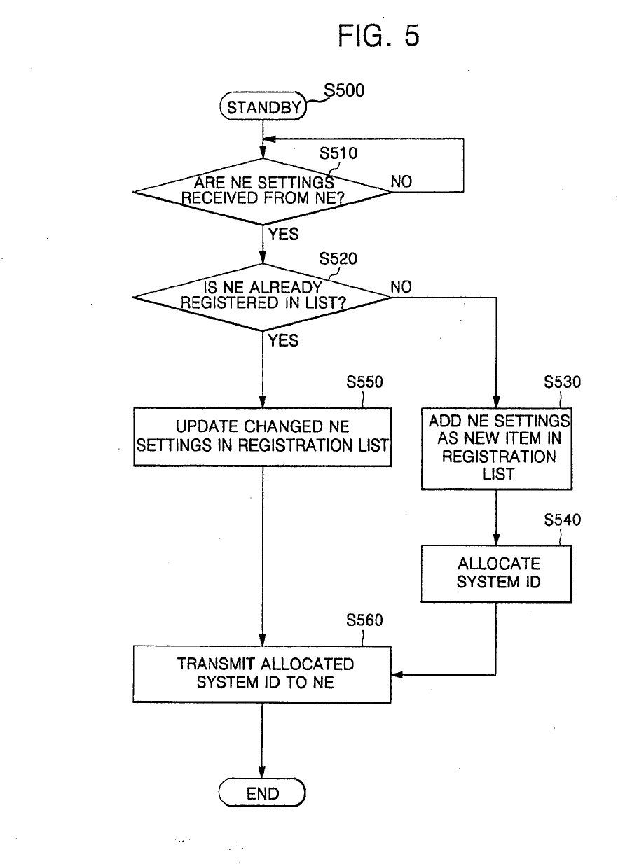

The operation of the management server according to the present invention will now be described in detail with reference to FIG. 5, which is a flowchart of the operation of the management server according to the invention.

In S500, the management server 200 stands by for NE settings to be received from a corresponding one of the NEs 210 to 260 which the management server 200 manages. If the NE settings, including MAC address, ID address and system object identifier, are received from the NE in S510, the management server 200 determines whether or not the NE is already registered in the registration list 270 based upon the MAC address extracted from the received NE settings in S520. That is, the management server 200 determines whether or not any data of the MacAddresses is identical to the received MAC address.

If no data is identical, the management server 200 determines that an initial registration process is being carried out and adds the received NE settings to the registration list 270 in S530. In this case, the MAC address, the IP address and the system object identifier are all added to the corresponding item.

After the step of adding the received NE settings to the registration list 270, the management server 200 allocates a system identifier to the NE in S540. The system identifier is newly allocated so as not to overlap with a previously allocated system identifier, and is then stored in the registration list 270.

If a datum of MacAddresses of the registration list 270 is determined to be identical to the received MAC address in S520, it is determined that the NE settings of the already registered NE are changed, and the received NE settings are compared to information stored in the registration list 270 in order to update the registration list 270 with a change in S550.

After the step of newly adding the NE settings or updating the change in the NE settings is accomplished, the management server 200 transmits the allocated system identifier to the NE so as to report that the NE settings have been updated normally in S560.

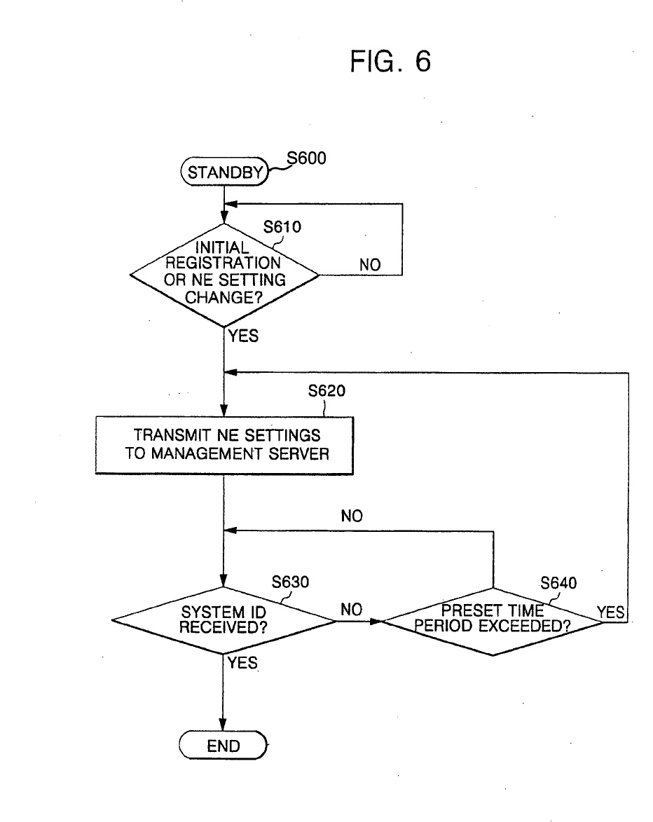

The operation of the NE according to the present invention will now be described in detail with reference to FIG. 6, which is a flowchart of the operation of the NE according to the invention.

The NE is in a standby state in S600, and determines whether an initial registration is required due to the NE initially connecting to the NE management system, or whether NE settings are changed, in S610.

If it is determined that initial registration is required or that the NE settings are changed in S610, the NE transmits the NE settings, including MAC address, IP address and system object identifier, to the management server 200 via the transmitter 430 in S620.

Upon completely transmitting the NE settings in S620, the NE determines whether a system identifier is received from the management server in S630. If the system identifier is normally received, the NE determines that the SE settings have been normally received by the management server 200 and that an updating of the registration list has been accomplished, and proceeds to the next step.

If it is determined in S630 that the system identifier is not received, the NE determines whether a preset time period has been exceeded in S640.

If it is determined that the preset time period has not been exceeded in S640, the process returns to S630 to wait for the system identifier to be received from the management server 200. If the preset time period has been exceeded, as determined in S640, it is concluded that the transmission of the NE settings has failed, and the process returns to S620 to retransmit the NE settings. The aforementioned process is carried out to ensure that the NE settings are normally transmitted to the management server 200 and that the updating of the registration list 270 can be normally carried out. Furthermore, if the NE settings, such as the IP address and the system object identifier, are changed through the aforementioned process, it is immediately reported to the management server 200 so that the management server 200 can properly manage the NE.

As set forth above, the NE management system of the invention can immediately reflect the change of the NE settings in the registration list 270, thereby managing the NEs without confusion.

Furthermore, in the NE management system which dynamically allocates IP addresses using the DHCP server so that the IP addresses of the NEs are changed, it is possible to correctly acquire the MIB of the NE which the management server 200 attempts to manage. As a result, this overcomes the problem of a conventional NE management system which classifies the NEs based upon IP addresses. As the initialization process is carried out using standardized SNMP, a further development in addition to SNMP is not necessary, and thus burdens for the development of SNMP can be relieved.

Moreover, since only the standardized SNMP protocol is used, any SNMP elements can be applied in an equivalent manner irrespective of NE types or manufacturers.

While the present invention has been shown and described in connection with preferred embodiments, it will be apparent to those skilled in the art that modifications and variations can be made without departing from the spirit and scope of the invention as defined by the appended claims.

What is claimed is:

1. A network element management system using Simple Network Management Protocol (SNMP), comprising:
a management server for receiving network element settings including a Media Access Control (MAC) address, an Internet Protocol (IP) address and a system object identifier from a network element, for acquiring an element type of the network element based upon the system object identifier to determine a Management Information Base (MIB) to use, for managing a registration list by classifying the network element based upon the MAC address, for allocating a system identifier to the network element, and for transmitting the allocated system identifier to the network element, thereby reporting that a registration process is accomplished;
wherein the network element transmits the network element settings to the management server when one of registration of the network element and a change in the network element settings occurs; and
wherein, when the system identifier is not transmitted from the management server within a preset time period, the network element retransmit the network element settings to the management server.

2. The network element management system according to claim 1, wherein the management server includes:
an SNMP manager for communicating data to an SNMP agent of the network element using SNMP;
an MIB setter for acquiring the element type with reference to the system object identifier, and for setting the MIB according an element version of the network element;
a registration list manager for generating the registration list including the MAC address, the IP address and the system object identifier, and for executing registration in and update of the registration list based upon the MAC address; and
a system identifier setter for setting the system identifier of the network element when the registration in or the update of the registration list is accomplished, and for transmitting the set system identifier to the network element via the SNMP manager.

3. The network element management system according to claim 2, wherein the SNMP manager transmits the system identifier, set by the system identifier setter, to the network element using an SNMP set request message so as to report that the registration in or the update of the registration list is accomplished.

4. The network element management system according to claim 1, wherein the network element includes:
an SNMP agent for communicating data to the management server using SNMP;
a setting change checker for generating the network element settings when said one of registration of the network element and change in the network element settings occurs, and for transmitting the generated network element settings to the management server via a transmitter of the SNMP agent;
a system identifier checker for determining whether the system identifier, which notifies that one of registration in and update of the registration list is accomplished, is received from the management server and, when the system identifier is not received within the preset time period, for retransmitting the network element settings to the management server; and
a system identifier memory for storing the system identifier when the system identifier is received in the system identifier checker within the preset time period.

5. The network element management system according to claim 4, wherein the SNMP agent transmits the network element settings generated by the setting change checker to the management server using a cold start SNMP trap message.

6. The network element management system according to claim 1, wherein the system object identifier is allocated with a first unique number for a manufacturer and a second unique number for a product group of the manufacturer so that the MIB is set according to a product type which is determined based upon the system object identifier.

7. The network element management system according to claim 1, wherein the management server allocates the system object identifier to the network element and transmits the system object identifier to the network element in order to report that the network element settings are received and that and that at least one of registration and update of the registration list is accomplished.

8. A network element management method using Simple Network Management Protocol (SNMP), comprising the steps, at a network element, of:
determining whether an initial registration is required when said network element is initially connected to a network management system using the SNMP or network element settings are changed;
when one of initial registration is required and the network element settings are changed, transmitting the network element settings, including a Media Access Control (MAC) address, an Internet Protocol (IP) address and a system object identifier, to a management server;
determining whether a system identifier is received from the management server after the network element settings are transmitted; and
normally stopping a process when the system identifier is received from the management server within a preset time period as a result of the determining step.

9. The network element management method according to claim 8, further comprising the step of retransmitting the network element settings to the management server when the system identifier is not received from the management server within a preset time period.

10. The network element management method according to claim 8, wherein an SNMP agent transmits the network element settings generated by a setting change checker to the management server using a cold start SNMP trap message.

11. A network element management method using Simple Network Management Protocol (SNMP), comprising the steps, at a management server, of:
standing by for network element settings to be received from a network element which is managed by the management server;
receiving the network element settings, including a Media Access Control (MAC) address, an Internet Protocol (IP) address and a system object identifier, from the network element;
determining whether the network element is already registered in a registration list using the network element settings received in the receiving step;
when the network element is not registered, determining that an initial registration process is being carried out and adding the received network element settings to the registration list;
allocating a system identifier to the network element after the step of adding the received network element settings to the registration list is accomplished;
when the network element is already registered, comparing the network element settings with information stored in the registration list to update the registration list with a change; and
transmitting the system identifier allocated to the network element after at least one of the step of allocating the system identifier to the network element after the step of adding the received network element settings to the registration list, and the update of the registration list, is accomplished.

12. The network element management method according to claim 11, wherein the step of determining whether the network element is already registered in the registration list using the received network element settings comprises determining whether MAC address data of the registration list is identical to the MAC address extracted from the network element settings.

13. The network element management method according to claim 11, wherein the step of allocating the system identifier to the network element comprises newly allocating the system identifier so as not to overlap with a previously allocated system identifier, and storing the newly allocated system identifier in the registration list.

14. The network element management method according to claim 11, wherein the step of transmitting the system identifier allocated to the network element comprises transmitting the system identifier to the network element using an SNMP set request message in order to report that one of the step of adding the network element settings to the registration list and the update of the registration list is accomplished.

15. The network element management method according to claim 11, wherein the system object identifier is allocated with a first unique number for a manufacturer and a second unique number for a product group of the manufacturer so that a Management Information Base (MIB) is set according to a product type which is determined based upon the system object identifier.
